(19) United States
(12) Patent Application Publication
(10) Pub. No.: US 2022/0120370 A1
(43) Pub. Date: Apr. 21, 2022

(54) MODULAR ROBOT FOR PIPELINE ISOLATION AND TESTING

(71) Applicant: SAUDI ARABIAN OIL COMPANY, Dhahran (SA)

(72) Inventors: Majed F. Rajeh, Riyadh (SA); Mohammed A. Alyousef, Riyadh (SA); Mohammad S. Ghamdi, Dammam (SA); Mohammed A. Ashour, Al Aujam (SA); Thamer F. Alzahrani, Riyadh (SA); Sultan A. Shaqaq, Al Ahsa (SA)

(73) Assignee: SAUDI ARABIAN OIL COMPANY, Dhahran (SA)

(21) Appl. No.: 17/072,414

(22) Filed: Oct. 16, 2020

(51) Int. Cl. F16L 55/128; F16L 55/18; F16L 55/44; F16L 55/32

(52) U.S. Cl. CPC F16L 55/1283; F16L 55/18; F16L 2101/30; F16L 55/32; F16L 55/44

(57) ABSTRACT

A modular isolation robot includes a motor configured to drive at least a first wheel, wherein the first wheel is configured to contact an interior surface of a pipe. The robot further includes a first rubber expander configured to selectively expand from a first state to a second state, wherein a diameter of the rubber expander in the second state is equal to an inner diameter of the pipe, and at least a first interchangeable module, wherein the first interchangeable module is configured to house an electronic component. A system for performing maintenance operations within a pipeline includes a first modular isolation robot and a second modular isolation robot.

### BACKGROUND OF INVENTION

### Background Art

In a modern oil and gas field, a large number of gathering lines lead from each well to process plants and then to distribution or refinery plants for further processing. The transport process occurs over a large network of pipelines which are operated by oil and gas producers.

Over the life of a pipeline, connections between pipes or pipes themselves may experience internal corrosion or other damage that is caused gradually by normal use. Additionally, most of the equipment along a pipeline is carefully inspected and maintained. For example, the pipeline inspection may be completed using ultrasonic testing (UT). The UT performed may help identify and locate defects within the pipeline. Understanding the internal conditions of the pipeline may help with making decisions about how to maintain a pipeline and maximize operation efficiency. Completing any necessary pipeline modifications or isolations quickly is key to reducing facilities downtime.

### SUMMARY OF INVENTION

This summary is provided to introduce a selection of concepts that are further described below in the detailed description. This summary is not intended to identify key or essential features of the claimed subject matter, nor is it intended to be used as an aid in limiting the scope of the claimed subject matter.

A modular isolation robot includes a motor configured to drive at least a first wheel, wherein the first wheel is configured to contact an interior surface of a pipe. The robot further includes a first rubber expander configured to selectively expand from a first state to a second state, wherein a diameter of the rubber expander in the second state is equal to an inner diameter of the pipe, and at least a first interchangeable module, wherein the first interchangeable module is configured to house an electronic component.

A system for performing maintenance operations in a pipe includes a first isolation robot. The first isolation robot includes a first motor configured to drive at least a first wheel, wherein the first wheel is configured to contact an interior surface of a pipe, a first rubber expander configured to selectively expand to an expanded diameter equal to an inner diameter of the pipe, and at least a first interchangeable module coupled, wherein the first interchangeable module is configured to house at least one electronic component. The system further includes a second isolation robot. The second isolation robot includes a second motor configured to drive at least a third wheel, wherein the third wheel is configured to contact an interior surface of a pipe, a second rubber expander configured to selectively expand to an expanded diameter equal to an inner diameter of the pipe, and at least a second interchangeable module coupled, wherein the second interchangeable module is configured to house at least one electronic component. The first isolation robot and the second isolation robot are disposed in the pipe.

### BRIEF DESCRIPTION OF DRAWINGS

FIG. 1 is a diagram of a pipeline isolation robot according to one or more embodiments disclosed herein.

FIG. 2 is a side cross-sectional view of a pipeline isolation robot in a casing according to one or more embodiments disclosed herein.

FIG. 3 is a side cross-sectional view of two pipeline isolation robots in a casing according to one or more embodiments disclosed herein.

### DETAILED DESCRIPTION

Presently, data collection and pipeline maintenance processes are carried out typically by isolating the pipeline at a pipeline block valve station. Isolating the pipeline includes steps of closing valves at the block valve station and completing a blow down process, which includes venting contents of the pipeline into the environment, to remove at least a portion of the pipeline contents prior to completing maintenance operations. Preparing the pipeline for maintenance in this way is time consuming, costly, and hazardous to the environment and on-site personnel.

Embodiments disclosed herein provide a pipeline isolation robot that is non-intrusive, tetherless, moves inside the pipe with wheels, and is remotely controlled. The isolation robot may be introduced to water or hydrocarbon fluids within metallic and/or nonmetallic pipe. The isolation robot has the capability to travel inside the pipeline without removing the product and can be operated with one or more carrier modules. The isolation robot may be used to complete maintenance jobs, surveillance and isolation for any part of the pipeline in response to events such as leaking pipe or fire. The isolation robot may be used to isolate a segment of the pipeline prior to completing repair work.

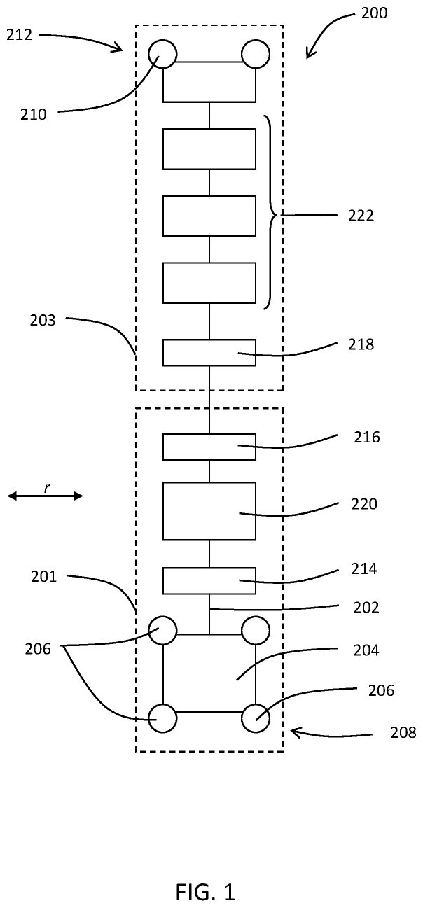

An example of a tetherless robot in accordance with embodiments of the present disclosure is shown in FIG. 1. The tetherless robot 200 includes several components assembled together at mechanical connections represented by lines 202. The mechanical connections may be rigid or flexible and may include direct or indirect couplings. In some embodiments, the coupling may include a tire coupling to absorb shock and reduce vibrations and torsional oscillations of the isolation robot. In some embodiments, two or more of the components may be integrally formed such that no additional mechanical connection therebetween is required. Two or more components of the tetherless robot 200 may also be electrically coupled in series or in parallel.

Robot 200 may be divided into different sections. For example, robot 200 includes a first section 201 having a first plurality of components therein and a second section 203 having a second plurality of components therein. The first section may be connected to the second section by a flexible coupling to facilitate the robot moving through curves or bends in the pipeline. The flexibility in the coupling accounts for profile changes that may occur over time. Components within the first and second sections may be removed, added, or otherwise rearranged.

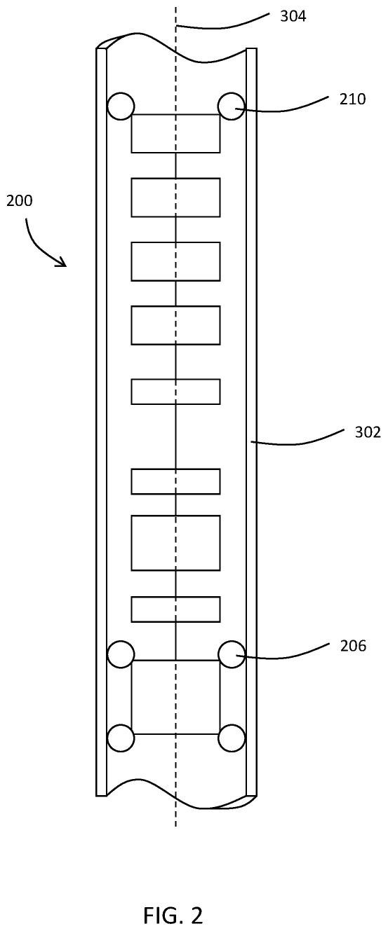

A first component of tetherless robot 200 is represented by component 204. Component 204 contains a motor, such as a DC motor, as well as a transmission assembly (not shown) linking the motor to one or more of a plurality of front wheels 206. The motor may be battery operated and spark-free. The motor is configured to motorize the wheels 206 for movement of the isolation robot. The transmission assembly may include racks, gears, axels or other components to transfer output motion from the motor to input motion at one or more wheels 206. In the embodiment shown in FIG. 2, four front 206 wheels are disposed at a first end 208 of the robot 200. One or more of front wheels 206 may be actively driven by the motor and transmission system while one or more may be passive wheels configured to rotate and stabilize the robot 200 as it moves either forward or backward within the pipeline. In some embodiments, all of the front wheels 206 are actively driven.

Additional back wheels 210 may be included at a second end 212 of the robot 200. Back wheels 210 may be passive wheels configured to roll and stabilize the tool 200 as it moves through a casing driven by active wheels near the first end 208 of robot 200. In some embodiments, one or more of the plurality of front wheels 206 and the plurality of back wheels 210 is configured to move in a radial direction, r. The wheels 206, 210 may be biased by, for example, a mechanical spring, hydraulic pressure, and/or pneumatic pressure, such that the wheels are located in an expanded position. The wheels may be pushed inward (i.e., toward a center longitudinal axis of the robot 200) when force is exerted on the wheels by, for example, the pipeline as will be discussed herein with respect to FIG. 2 below. The biasing aspect of the movable wheels allows the robot 200 to apply pressure to the pipe and ensures that active wheels have adequate traction for propelling the robot 200 through the pipe. The ability for the wheels to move radially allows the robot 200 to accommodate variations in pipe diameter. In some embodiments, the robot 200 can tolerate a deviation in pipeline roundness greater than approximately 5%. The compliant wheel system may further allow the robot to accommodate for various profile changes within a pipeline (e.g., changes to the internal diameter of the pipeline) and to travel through angled, curved, or bent portions of the pipeline without becoming stuck. The compliant wheel system allows the isolation robot to be used in a variety of pipelines having different internal diameter sizes.

Proximal to the component 204 is a rubber expander 214 having an initial diameter less than a diameter of the pipeline in which robot 200 is to be inserted. The rubber expander 214 can be selectively actuated to expand in a radial direction such the diameter of the rubber expander 214 increases and the expander contacts and seals against the pipeline internal dimeter. The rubber expander may be actuated to form a barrier or otherwise isolate a portion of the pipeline. It may be desirable to isolate a portion of the pipeline prior to performing pipeline operations such as cleaning, maintenance, or testing. The rubber expander 214 may also be used to block a portion of the pipeline that is no longer in use. Additional rubber expanders 216, 218 may be located on the robot 200. The additional expanders may be selectively actuated at the same time or at different times than the rubber actuator 214 to reinforce the seal between the rubber expander 214 and pipeline or to isolate one or more lengths of pipeline in between the actuated expanders 214, 216, 218. Pressure and temperature sensors, as well as location sensors, may provide input to the isolation robot and/or an operator to trigger automatic or manual actuation of the seals. The seals created by the rubber expanders can be selectively released after actuating. For example, the rubber expander may include a flexible membrane configured to selectively expand or contract to create or release a seal, respectively. Rubber expanders may be configured such that the expanded state is passive and does not require power input to maintain.

Module 220 is illustrated between rubber expanders 214, 216. Module 220, as well as one or more proximal components represented collectively as module 222, may include equipment associated with one or more tasks such as measurement and logging (e.g., ultrasonic sensors and on-board data storage capacity for storing collected data), location sensing (e.g., GPS sensors), in line inspection (e.g., video cameras, still cameras, and lighting), communication (e.g., antennas for transmitting collected data when requested, at predetermined time intervals, or in substantially real time to the surface), sampling, cleaning, pumping, maintenance, and leak detection. Modules 220, 222 may additionally or alternatively include batteries or cleaning fluid (e.g., a canister of nitrogen or other inert gas). Module 222 may be referred to also as one or more carrier modules. Any number of carrier modules may be a part of the isolation robot, and modules may be added or removed as needed. Module 220 and 222 may be modular, removable, or otherwise interchangeable with other modules that house different combinations of equipment therein. The interchangeable modules may be quickly assembled and disassembled at the scraper launcher and receiver such that particular combinations of modules may be coupled together to build a robot specific to the types of operations the robot will perform.

Power may be supplied to the motor by one or more batteries that can be housed within first or second sections 201, 203. The batteries (not shown) are configured to supply sufficient power to the robot for the robot to move within a pressurized, fluid-filled pipeline a distance of at least 50 kilometers at climbing angles that may be greater than 35° with horizontal. In some embodiments, batteries may be sized such that the robot can travel at least 100 kilometers. The robot may track and/or communicate the battery level to an operator so that the robot may be retrieved and batteries replaced as needed. In some instances, if the battery dies and the seal is not removed, the robot will act as temporary plug or may move with the fluid flow in the pipeline. In some embodiments, the isolation robot may include wireless battery recharging capabilities.

In some embodiments, a positioning sensor, such as a GPS, may collect and transmit data via an antenna at substantially the same time that an onboard camera collects and transmits images of the inside of the pipeline. An operator or image processing system, such as a computing device with a processor and memory, may view the images and detect portions of the pipeline that require maintenance and may associate the required action with the location of robot 200 when the image was acquired. The robot may be driven remotely to the location and may be instructed to perform the associated required maintenance. In some embodiments, maintenance operations may include actuating at least one rubber expander 214, 216, 218 and releasing nitrogen gas from a canister on board the robot 200. Pipeline fluid may be displaced by the nitrogen gas, thereby creating a volume of nitrogen gas around the area of the pipeline segment where maintenance work will be performed. In some embodiments, maintenance operations may include cleaning and/or repairing a weld joint or hot taping area within the pipeline. Maintenance operations can also include pushing the product contained within an isolated portion of the pipeline out of a small area thereby dispersing the product from an isolated volume and creating a safe area for working on the pipeline.

Referring to FIG. 2, robot 200 is illustrated within a section of pipe 302. Pipe 302 may be a metallic or non-metallic material. As discussed above, front and back wheels 206, 210, respectively, may be biased to push outward (i.e., away from a longitudinal mid-line 304 of the robot 200) to facilitate sufficient force between the wheels and the pipe. Having sufficient force between the wheels and the pipe allows the active wheels to drive the robot 200 either forward or backward (i.e., bi-directionally) within the pipeline, as instructed by a remote operator or by an on board computer.

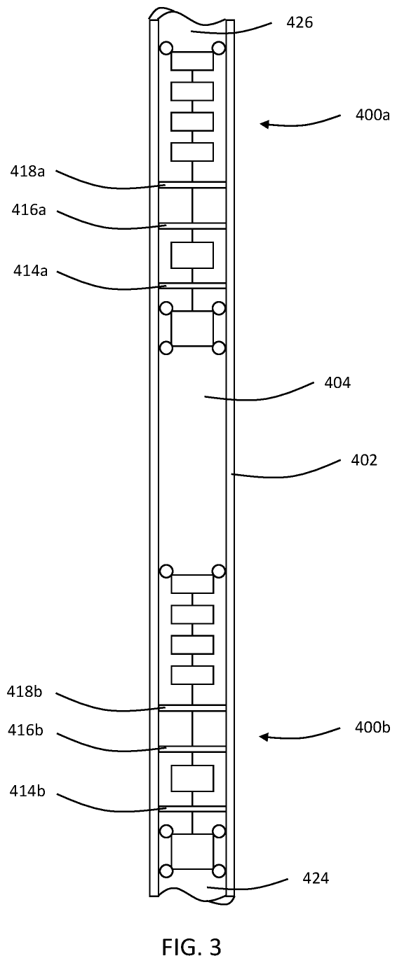

FIG. 3 illustrates a section of pipe 402 that includes a first robot 400a and a second robot 400b therein. The robots 400a, 400b are shown having actuated rubber expanders 414a, 414b, 416a, 416b, 418a and 418b to isolate a volume 404 between the robots 400a, 400b within the pipeline segment 402. The volume 404 may be filled with pipeline fluid, nitrogen gas, or other fluid contained onboard one or more of the robots and subsequently released into the pipeline segment. Deploying two robots enables isolating a volume 404 at any point along the casing 402 as described. It may be advantageous to fill the volume 404 with nitrogen prior to completing a cleaning or repair operation, as the nitrogen creates a safer downstream environment in which to work.

Alternatively, two robots may be used to double the number of seals between a distal portion 424 of the casing and a proximal portion 426 of the casing. Using multiple robots may be particularly useful when a high pressure and/or low density fluid is present in the distal portion 424 of the pipeline which could break through one or more seals actuated by a single robot.

In another two-robot configuration, the first robot 400a may actuate one or more of rubber expanders 414a, 416a, 418a to isolate the proximal portion 426 of the pipeline from the distal portion 424 of the pipeline. The second robot 400b may remain mobile within the pipeline segment to complete cleaning, maintenance, repair, or other operations using onboard tools such as vacuum pumps. While robots 400a, 400b are shown having the same component configuration, different configurations can be used on the different robots. Additionally, in some embodiments, robots may be configured to communicate wirelessly with each other to facilitate cooperation and to prevent unwanted contact between the two robots.

Similar to the two-robot configuration, an alternative configuration includes a single robot having first and second sections as described with respect to FIG. 1. Connecting the first and second sections is an extendable connection that allows the first and second sections to be spaced apart. Each of the first and second sections may include a rubber expander for creating seals against the casing in each respective location. In some embodiments, the first and second sections can be separated by a distance between approximately 1 meter and approximately 3 meters, though other distances are possible without departing from the scope of the present disclosure.

Robots described herein may include a protective shell around the components described. The shell may be formed in a cylinder, cone, or other shape or size that can fit within a particular casing. The components and/or the shell may be formed from material that does not spark or explode. The materials and construction may further withstand exposure to high pressure water and hydrocarbon fluids over long periods of time without degradation.

The quick response of one or more robots within the pipeline may reduce downtime associated with removing existing tools and introduce process-specific tools into the pipeline to complete cleaning, maintenance, or plugging tasks. Reducing pipeline downtime in turn can reduce lost production. Furthermore, in the event of a pipeline control incident, the robot may quickly be deployed to effect a seal that may help contain or control dangerous events associated with low density fluid bubbles or other disruptions in hydrostatic pressure within the pipeline. The ability to mitigate pipeline control event risks may eliminate the need to perform environment-damaging blow down operations.

The robots may be removed from the pipeline using a scraper receiver and/or reinserted into the pipeline using a scraper launcher at pump stations or valve stations. The robots may be manually operated by an operator located at the pump or valve stations. The operator may communicate instructions to the robot wirelessly via equipment carried on board the robot. The robot may carry out certain operations autonomously or semi-autonomously using information and programming stored on board the robot or otherwise remotely accessed by the robot.

The modular robots and methods for operating the robots discussed herein provide several benefits over the traditional tools and processes used to carry out maintenance and isolation processes in a pipeline. The robots can be readily available at the pump stations for quickly responding to emergency situations or standard maintenance instructions. Because the contents of the pipeline do not need to be vented prior to using the robots to complete maintenance operations, the pipeline is less harmful to the environment. Additionally, the pipeline can be maintained on a more regular basis which keeps the pipeline free from corrosion, which can make the pipeline safer and more efficient. The condition of the pipeline can be regularly monitored using the robot to detect damage, leaks, or other anomalies to improve safety and production of the pipeline. The ability to carry out various pipeline processes with a robot without removing contents of the pipeline also reduces costly downtime.

While various configurations and methods of operating a pipeline isolation robot have been described with respect to a limited number of embodiments, those skilled in the art, having benefit of this disclosure, will appreciate that other embodiments can be devised which do not depart from the scope of the present disclosure. Accordingly, the scope of the disclosure should be limited only by the attached claims.

What is claimed is:

1. A modular isolation robot comprising:
a motor configured to drive at least a first wheel, wherein the first wheel is configured to contact an interior surface of a pipe;
a first rubber expander configured to selectively expand from a first state to a second state, wherein a diameter of the rubber expander in the second state is equal to an inner diameter of the pipe; and
at least a first interchangeable module, wherein the first interchangeable module is configured to house an electronic component.

2. The modular isolation robot of claim 1, comprising at least a second wheel, wherein the first and second wheels are biased to push away from a midline of the robot.

3. The modular isolation robot of claim 2, wherein the first and second wheels are configured to be pushed toward the midline of the robot by the interior surface of the pipe.

4. The modular isolation robot of claim 2, wherein the first wheel is disposed near a first end of the robot and wherein the second wheel is disposed near a second end of the robot.

5. The modular isolation robot of claim 1, wherein the second state of the rubber expander is configured to be passively maintained.

6. The modular isolation robot of claim 1, further comprising a shell to enclose at least the first interchangeable module, wherein the shell comprises a non-sparking material.

7. The modular isolation robot of claim 1, wherein the robot is physically tetherless and remotely controlled.

8. The modular isolation robot of claim 1, wherein the electronic component is at least one selected from a group consisting of a positioning sensor, an ultrasonic sensor, a camera, a battery, and an antenna.

9. The modular isolation robot of claim 8, wherein the battery comprises a capacity to power the robot for a distance of at least 50 km in the pipe.

10. The modular isolation robot of claim 8, wherein the camera is configured to capture a plurality of images inside the pipe and transmit the images to a remote operator or a computing device.

11. The modular isolation robot of claim 1, further comprising a second interchangeable module configured to store and selectively release nitrogen gas.

12. The modular isolation robot of claim 1, wherein the motor is configured to drive the robot in a forward direction and in a backward direction.

13. A system for performing maintenance operations in a pipe, the system comprising;
a first isolation robot comprising:
a first motor configured to drive at least a first wheel, wherein the first wheel is configured to contact an interior surface of a pipe;
a first rubber expander configured to selectively expand to an expanded diameter equal to an inner diameter of the pipe; and
at least a first interchangeable module coupled, wherein the first interchangeable module is configured to house at least one electronic component;
a second isolation robot comprising:
a second motor configured to drive at least a third wheel, wherein the third wheel is configured to contact an interior surface of a pipe;
a second rubber expander configured to selectively expand to an expanded diameter equal to an inner diameter of the pipe; and
at least a second interchangeable module coupled, wherein the second interchangeable module is configured to house at least one electronic component,
wherein the first isolation robot and the second isolation robot are disposed in the pipe.

14. The system of claim 13, wherein the first rubber expander is configured to passively seal against the interior surface of the pipe in a first location and wherein the second rubber expander is configured to passively seal against the interior surface of the pipe in a second location to create a sealed volume between the first location and the second location.

15. The system of claim 14, wherein at least one of the first and second isolation robots further comprises a volume of selectively releasable nitrogen gas.

16. The system of claim 15, wherein the selectively releasable nitrogen gas is configured to be released into the sealed volume.

17. The system of claim 15, wherein at least one of the first and second robots further comprises maintenance equipment and is configured to perform maintenance operations within the sealed volume.

18. The system of claim 17, wherein the maintenance equipment comprises at least one selected from a group consisting of a vacuum pump and a camera.

19. The system of claim 13, wherein at least one of the first and second isolation robots comprises an antenna configured to send information to a remote operator and to receive instructions from a remote operator.

20. The system of claim 13, wherein at least one of the first and second isolation robots comprise a shell formed from a non-sparking material.
